(19) United States
(12) Patent Application Publication
(10) Pub. No.: US 2009/0166214 A1
(43) Pub. Date: Jul. 2, 2009

(54) Porous Ceramic Materials

(75) Inventors: Tao T. Tao, Hopkinton, MA (US); Linda Bateman, Spencer, MA (US)

Correspondence Address: WOLF GREENFIELD & SACKS, P.C., 600 ATLANTIC AVENUE, BOSTON, MA, 02210-2206, US

(73) Assignee: CellTech Power LLC, Westborough, MA (US)

(21) Appl. No.: 12/114,711

(22) Filed: May 2, 2008

Related U.S. Application Data
(60) Provisional application No. 60/927,434, filed on May 2, 2007.

(51) Int. Cl. C25B 9/00; C03B 19/00

(52) U.S. Cl. 205/334; 501/80

(57) ABSTRACT

The present invention relates to porous articles, including porous ceramic materials, which can be used in a variety of settings, but find particular use in connection with electrochemical devices such as fuel cells, as well as methods of their manufacture and use. The porous ceramic may have, in some aspects of the invention, an average pore size of between about 1 micrometer and about 300 micrometers, and in some cases, certain advantageous permeability characteristics with respect to species useful in certain types of electrochemical devices. In some cases, the ceramic may be sufficiently porous to allow gaseous molecules (e.g., air or oxygen, gaseous fuels, etc.) and/or liquids (e.g., water or liquid fuels) to be transported therethrough, and/or the ceramic may be substantially resistive or impermeable to a liquid such as a non-wetting liquid, for instance, a liquid metal such as liquid (molten) tin. Another aspect of the invention is generally directed to systems and methods of forming such porous ceramics. In one set of embodiments, a porous ceramic may be formed by impregnating a template (for example, an interconnected template, typically three-dimensional) with a ceramic precursor, causing the ceramic precursor to form a ceramic having an open channel structure, and removing the template. The ceramics of the present invention may find use in a wide variety of applications, including kiln furniture, filters, catalyst supports, fuel cells, carriers for absorbents, insulators, or separators (e.g., for a burner and a flame), and the ceramics may be useful at a broad range of temperatures. For example, a ceramic may be used to separate a fuel from an electrode in a fuel cell (for instance, by converting fuel molecules to produce reaction products), as the ceramic may be permeable to a gas and/or a liquid. Other aspects of the invention relate to kits involving such ceramics, methods of promoting the making or use of such ceramics, and the like.

### RELATED APPLICATION

This application claims priority to U.S. Provisional Patent Application Ser. No. 60/927,434, filed May 2, 2007, entitled “Porous Ceramic Materials,” which is incorporated herein by reference.

### FIELD OF INVENTION

The present invention generally relates to ceramics and, in particular, to porous ceramic materials, including materials having an interconnected pore structure.

### BACKGROUND

Porous ceramics are desirable for a wide variety of applications. As ceramics, such materials can withstand relatively high temperatures before degradation or decomposition occurs. A porous structure has lighter weight, relative to a similar, non-porous structure. In addition, if sufficiently porous and open, materials can flow through the pores of the ceramic, e.g., from one side of the ceramic to the other, with less diffusion resistance. However, porous ceramics are difficult to fabricate, and improved techniques are still needed.

### SUMMARY OF THE INVENTION

The present invention relates to porous ceramic materials. The subject matter of the present invention involves, in some cases, interrelated products, alternative solutions to a particular problem, and/or a plurality of different uses of one or more systems and/or articles.

In one aspect, the invention is directed to a method. In one set of embodiments, the method includes acts of providing a template for a ceramic porous structure, at least partially infusing the template with a liquid comprising a ceramic precursor, and heating the ceramic precursor to a temperature that allows the precursor to form a ceramic having interconnected channels and an average pore size, as determined by mercury porosimetry, of less than about 300 micrometers. The method, in another set of embodiments, includes acts of providing a template for a ceramic porous structure, at least partially infusing the template with a liquid comprising a ceramic precursor, causing the ceramic precursor to form a ceramic, and removing substantially all of the template from the ceramic.

According to yet another set of embodiments, the method includes acts of providing an electrochemical device comprising an electrode, a substantial portion of which is liquid at an operating temperature of the device, and a porous article adjacent at least a portion of the electrode for supporting the electrode in a liquid state, where the porous article is substantially permeable to a gas, and operating the device with substantial containment, by the porous article, of the electrode when the electrode is liquid while allowing passage, through the porous article, of the gas which participates in a reaction involving the device.

The invention is directed to a fuel cell in another aspect. In one set of embodiments, the fuel cell includes a porous ceramic having an average pore size, as determined by mercury porosimetry, of between about 1 micrometers and about 300 micrometers, defining a separator between a first chamber constructed and arranged to contain a fuel, and a second chamber containing an anode. The fuel cell, in another set of embodiments, includes a porous ceramic having a porosity of at least about 60%, defining a separator between a first chamber constructed and arranged to contain a fuel, and a second chamber containing an anode. In yet another set of embodiments, the fuel cell includes a ceramic having a porosity of at least about 60%, defining a separator between a first chamber constructed and arranged to contain a fuel, and a second chamber containing an anode.

In another aspect, the present invention is directed to a method of making one or more of the embodiments described herein, for example, a porous ceramic. In another aspect, the present invention is directed to a method of using one or more of the embodiments described herein, for example, a porous ceramic.

Other advantages and novel features of the present invention will become apparent from the following detailed description of various non-limiting embodiments of the invention. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### DETAILED DESCRIPTION

The present invention relates to porous articles, including porous ceramic materials, which can be used in a variety of settings, but find particular use in connection with electrochemical devices such as fuel cells, as well as methods of their manufacture and use. The porous ceramic may have, in some aspects of the invention, an average pore size of between about 1 micrometer and about 300 micrometers, and in some cases, certain advantageous permeability characteristics with respect to species useful in certain types of electrochemical devices. In some cases, the ceramic may be sufficiently porous to allow gaseous molecules (e.g., air or oxygen, gaseous fuels, etc.) and/or liquids (e.g., water or liquid fuels) to be transported therethrough, and/or the ceramic may be substantially resistive or impermeable to a liquid such as a non-wetting liquid, for instance, a liquid metal such as liquid (molten) tin. Another aspect of the invention is generally directed to systems and methods of forming such porous ceramics. In one set of embodiments, a porous ceramic may be formed by impregnating a template (for example, an interconnected template, typically three-dimensional) with a ceramic precursor, causing the ceramic precursor to form a ceramic having an open channel structure, and removing the template. The ceramics of the present invention may find use in a wide variety of applications, including kiln furniture, filters, catalyst supports, fuel cells, carriers for absorbents, insulators, or separators (e.g., for a burner and a flame), and the ceramics may be useful at a broad range of temperatures. For example, a ceramic may be used to separate a fuel from an electrode in a fuel cell (for instance, by converting fuel molecules to produce reaction products), as the ceramic may be permeable to a gas and/or a liquid. Other aspects of the invention relate to kits involving such ceramics, methods of promoting the making or use of such ceramics, and the like.

The following applications are incorporated herein by reference: a U.S. provisional patent application filed on May 2, 2007, entitled “Cathode Arrangements for Fuel Cells and other Applications,” by T. Tao (U.S. Pat. Apl. Ser. No. 60/927,435); and a U.S. patent application filed on May 2, 2007, entitled “Electrochemical Device Configurations,” by T. Tao, et al. (U.S. patent application Ser. No. 11/800,050).

One aspect of the invention is directed to a porous ceramic material. In one set of embodiments, the ceramic is a “refractive” ceramic, i.e., the ceramic can withstand a temperature of at least about 900 K, at least about 1000 K, at least about 1250 K, at least about 1500 K, at least about 1750 K, or at least about 2000 K without substantial degradation, i.e., such that the ceramic begins to lose its overall porosity. Examples of refractive ceramics that may be useful in the present invention include, but are not limited to, ZrO₂ (which may be stabilized with dopant materials or unstabilized), Al₂O₃, Si₃N₄, SiC, BN, ZrP, silica/quartz, mellite, silica/alumnia, or oxides of one or more of Cr, Ba, Ca, Sr, Mg, Be, Na, K, Sc, Y, La, Ti, Hf, V, Nb, Ta, Mo, W, Mn, Fe, Co, Ni, B, Al, Ga, In, C, Ge, Sn, S, P, and/or one or more rare earth elements. Such materials can be readily identified, for example, by forming a ceramic sample of the material and determining if any degradation occurs (e.g., change in the shape or porosity of the sample) when exposed to temperatures of at least about 900 K, at least about 1000 K, etc. In some embodiments, these materials are used in substantially pure form. However, combinations of these and/or other materials may also be useful, in other embodiments of the invention.

As used herein, “porous” means containing a plurality of openings; this definition includes both regular and irregular openings, as well as openings that generally extend all the way through a structure as well as those that do not (e.g., interconnected, or “open” pores, as opposed to at least partially non-connected, or “closed” pores). Thus, an interconnected porous structure is one where a significant fraction of the pores extends all the way through the structure. The porous ceramic membrane may have any suitable porosity. For example, the interconnecting porous ceramic may have a porosity of at least about 50%, at least about 60%, at least about 70%, at least about 75%, or at least about 80% (where the percentages indicate void volume within the ceramic), or the interconnecting porous ceramic may have an average pore size of less than about 300 micrometers, for example, less than about 100 micrometers, between about 1 micrometer and about 300 micrometers, between about 50 micrometers and about 200 micrometers, or between about 100 micrometers and about 200 micrometers. The average pore size may be determined, for example, from density measurements, from optical and/or electron microscopy images, or from porosimetry, e.g., by the intrusion of a non-wetting liquid (often mercury) at high pressure into the material, and is usually taken as the number average size of the pores present in the material. Such techniques for determining porosity of a sample are known to those of ordinary skill in the art. For example, porosimetry measurements can be used to determine the average pore size based on the pressure needed to force liquid into the pores of the sample. In one embodiment, the porous ceramic is substantially permeable to gaseous molecules (e.g., air or oxygen, gaseous fuels, etc.) and/or liquids (e.g., water, liquid fuels, liquid hydrocarbons, etc.); for example, the substantially permeable porous ceramic may have a permissivity to air of at least about 0.1 cm³/min cm/psi (under standard conditions, i.e., standard temperature or pressure), at least about 0.3 cm³/min cm/psi, at least about 1 cm³/min cm/psi, at least about 5 cm³/min cm/psi, or at least about 1000 cm³/min cm/psi. One method of determining permissivity is to measure a flow rate (e.g., in cm³/min) of a flowing media such as air or oxygen passing through a sample (e.g., a porous ceramic) having a known thickness (cm) and cross sectional area (cm²) under a given pressure (psi, 1 psi=6.89475 kPa).

In certain instances, for example, in applications involving fuel cells such as those described below, the porous ceramic is substantially permeable to gases but substantially impermeable to non-wetting and/or high surface tension liquids, for example, liquid metals such as liquid (molten) tin. In many cases, such liquids will form a repulsive meniscus, relative to the ceramic, i.e., the liquid does not “wet” the ceramic. That is, at temperatures at which tin (or other metal) becomes a liquid, a container formed of the porous ceramic that contains the liquid tin (under a predetermined pressure, such as 1 psi, about 6.9 kPa) will not show any substantial transport (convective bulk flow) of tin across the container, even after a time period of at least about a day, and often after time periods on the order of months; in some cases, no detectable movement of tin across the container will have occurred.

Another aspect of the invention is directed to methods of producing porous ceramic materials such as those described above. In one set of embodiments, an interconnected template (typically three-dimensional) is used to produce the porous ceramic. Generally speaking, a ceramic precursor is infused into the template (the infusion of the precursor into the template may be partial or total), then the ceramic precursor is set to form a ceramic green body (a partially solidified object) and/or fired to produce the final porous ceramic. Partial infusion of the ceramic precursor into the template may occur when there is a region of the template (e.g., a region substantially larger than a pore of the template) in which no ceramic precursor is present. The ceramic precursor is a material that when cured or fired, using techniques such as those described herein, produces a ceramic. Typically, the template is removed during the firing process, for example, by gasification, oxidation, and/or decomposition, as discussed herein

The template may be any suitable structure that itself is sufficiently porous to allow a ceramic precursor to enter, and typically, the template is formed of a material that has a three-dimensional interconnected structure and will gasify (i.e., can be converted into gaseous products), oxidize, and/or decompose, e.g., at higher temperatures. For example, during decomposition or oxidation, a portion of the material may be reacted such that part of the material forms a gaseous compound. Thus, the template can be removed during the process of forming the porous ceramic, in some embodiments of the invention. For example, the template may be composed of a polymer, such as polyurethane (e.g., a porous polyurethane, such as polyurethane foam). In some cases, the polymer will have a porosity of at least about 100 ppi, at least about 200 ppi, or at least about 300 ppi (pores per inch). Many polymers will gasify, oxidize, and/or decompose at relatively high temperatures, and those of ordinary skill in the art will be able to determine the temperature at which such processes (e.g., gasification or degradation) occurs for a given polymer, without an undue amount of experimentation. The template thus essentially forms the “negative” of the final porous ceramic. For instance, if a porous ceramic having a porosity of about 70% is desired, a ceramic precursor should have a maximum porosity or loading of about 30% (compensated for effects such as dry weight, shrinkage, etc.) to produce the final porous ceramic. Accordingly, a template having sufficient porosity to allow such loading may be used.

The average pore diameter of the ceramic can be controlled, in some embodiments, by controlling the template (for example, by selecting a template having a suitable porosity), and/or controlling the loading of the ceramic precursor, i.e., the amount of precursor material infused, partially or totally, into the template. In some cases, the template may be processed (for instance, distorted) in some fashion before setting and/or firing the ceramic precursor, e.g., to produce a material having the desired porosity and/or shape. The template may be processed before, during, or after infusion of the ceramic precursor. For example, the template may be compressed or stretched to produce a desired porosity. Any method may be used to process the template, until a desired shape, size, and/or porosity is achieved. For example, a template may be physically (mechanically) compressed, stretched, cut into smaller pieces, shaped, molded, or the like.

The ceramic precursor may be infused into the template through any suitable technique. In one set of embodiments, the ceramic precursor is a flowable material (e.g., a liquid or a slurry, which is a liquid containing a suspension of solids), and dipping, squeezing, sponging, and/or pressure is used to infuse the precursor into the template. For example, a predetermined amount of liquid precursor may be mechanically applied to the template, and subsequent sponging of the precursor may be used to ensure a substantially uniform loading, or a pressure may be mechanically applied to a liquid precursor to cause the precursor to at least partially infuse the template.

After infusion, the template may be heated to set or cure the ceramic precursor and/or to remove the template. For example, the template may be allowed to set at ambient temperature, heated to a temperature at least sufficient to cause the ceramic precursor to cure to form a ceramic green body, and/or the template may be heated to a temperature at least sufficient to cause gasification, oxidation, and/or decomposition of the template. If a ceramic green body is formed, it may be subsequently heated to form a ceramic. For example, the ceramic green body may be heated to a temperature of at least about 500° C., at least about 750° C., or at least about 1000° C. to produce the final ceramic, depending on the ceramic precursor and the application.

In some cases, the template may be heated to set the ceramic precursor (e.g., forming a green body), then the template removed by another process, for example, chemically. In other cases, however, the template may be heated to a temperature sufficient to cause both setting of the ceramic precursor, and removal of the template (e.g., by gasification, oxidation and/or decomposition). For example, a polymeric template, such as a foam, may be gasified or oxidized to form CO, CO₂, and/or H₂O (and also other gases, in some cases, e.g., NO or NO₂ if nitrogen is present), which can be removed as gases from the ceramic as it cures. Those of ordinary skill in the art will be able to identify suitable firing temperatures for a ceramic precursor without an undue amount of experimentation. For instance, for a commercial ceramic precursor containing alumina (Al₂O₃), such as Alumina Rigidizer (Zircar Ceramics, #A17401), or for a commercial ceramic precursor containing zirconia (ZrO₂) such as 904 Zirconia (Cotronic Corp.), the ceramic may be heated to a temperature of at least about 900° C.

Another aspect of the invention is directed to various uses of such porous ceramics. In one set of embodiments, the porous ceramics may be used as “kiln furniture,” which is used to hold pottery or ceramics during firing in a kiln. The ceramic may be prepared in any of a wide variety of shapes and sizes, such as posts, shelves, props, rod, cylinders, disks, or other supports. Porous ceramics may find use as kiln furniture since it is desired that such furniture is able to withstand high temperatures without significant distortion, e.g., such that it can no longer be used repeatedly as kiln furniture. The porous nature of the ceramic may allow the piece to have a smaller thermal mass (total heat capacity), and thus, it may cool down more rapidly after use, e.g., between firings.

Another set of embodiments of the invention are directed to uses of such porous ceramics in filters. For example, the ceramic may be used as a size-selective filter, e.g., able to separate various species on the basis of the pore size of the ceramic. Depending on the pore size of the porous ceramic, particles or species on the order of micrometers may be separated from larger particles or species. For example, a gas or a liquid may be passed through a porous ceramic, and larger particles or species may be retained by the porous ceramic, while smaller particles or species (i.e., smaller than the pore size of the porous ceramic) may pass through the porous ceramic.

Still another set of embodiments of the invention are directed to use of the porous ceramic as a support, e.g., for a catalyst, or as an absorbent. As such ceramics have a relatively open structure and a high surface area due to their porosity, and can withstand relatively high temperatures, such ceramics may be used as a catalyst supports or absorbents. Thus, for example, a catalyst, such as ruthenium, may be adsorbed onto the surface of the ceramic.

The invention, in yet another set of embodiments, is directed to a separator comprising a porous ceramic, such as those described herein. For example, the porous ceramic may be used to separate a chamber into a first compartment and a second compartment. While bulk flow of a fluid across the porous ceramic may not be readily achieved, gases and/or liquids may be able to be transported through the interconnected pores of the porous ceramic, and thus, there can be some contact between fluids in the first compartment and the second compartment, even if there is no bulk flow of fluid.

In still another set of embodiments, the porous ceramic may be used as a component of a fuel cell or other electrochemical device. An electrochemical device generally is one that can chemically react a species (e.g., electrochemically) to produce electricity. For example, the porous ceramic may be used to separate two compartments, and allow transport of one or a few species to occur between the two compartments, e.g., through the pores of the porous ceramic. For example, a porous ceramic may be used as a separator in a fuel cell. As used herein with respect to fuel cells or other electrochemical devices, a “separator” is any article that can be positioned, relative to a fuel and an electrode (e.g., an anode) or electrolyte of an electrochemical device such as a fuel cell, such that the electrode or electrolyte and fuel are able to communicate chemically and/or physically across the separator, which may, in some cases, promote oxidation of the fuel, for example, using gaseous fuels. In some cases, lighter hydrocarbons may pass across the porous ceramic.

A specific, non-limiting example follows. A porous ceramic separator may be positioned, relative to a fuel and an anode, such that the anode and fuel are able to communicate chemically and/or physically across the separator, providing an interface for oxidation of the fuel, e.g., using oxygen. The pores of the separator may allow contact directly between fuel and anode, and also contain the anode in some cases. Increasing the effective area for interaction may be performed physically by providing a framework that improves the interfacial area between the anode and fuel. In some cases, an interconnected pore structure of the ceramic may also reduce the diffusion path, e.g., of a fuel, and/or may reduce fuel diffusion polarization within the pores of the ceramic. In some cases, a pore diameter on the order of micrometers (e.g., 100 to 300 micrometers) may reduce flow resistance of the porous ceramic, e.g., by reducing wall collisions of a species flowing through the porous ceramic. Accordingly, a lower driving force (e.g., a pressure drop) may be needed to transport the species across the porous ceramic. Thus, in one such embodiment, a separator may comprise an open structure through which the anode and fuel can contact one another.

As used herein, “flow” means bulk or convective movement of one species into another species or compartment, e.g., where a liquid anode and a gaseous fuel are prevented from flowing into each other or into each other's compartment, the gaseous fuel does not bubble into the liquid anode, and/or the liquid anode does not penetrate the separator and/or flow into the fuel compartment. The meaning of “flow” herein does not, however, exclude diffusion. For instance, gaseous fuel may diffuse into a liquid anode, e.g., fuel molecules can become dissolved or dispersed within the liquid anode, although there may be no bulk movement of gaseous fuel within the anode (e.g., bubbles). In another embodiment, gaseous fuel may be allowed to actually flow through the separator and bubble into a liquid anode, but the anode material is prevented from bulk flowing into the fuel.

A variety of electrochemical devices can benefit from the present invention. Wherever “fuel cell” is used in any of the references incorporated herein, it is to be understood that any electrochemical device, including all disclosed herein, can be substituted. Non-limiting examples of electrochemical devices are disclosed in International Patent Application No. PCT/US01/12616, filed Apr. 18, 2001, entitled “An Electrochemical Device and Methods for Energy Conversion,” by T. Tao, et al., published as WO 01/80335 on Oct. 25, 2001, incorporated herein by reference.

A wide variety of fuels can be used with a fuel cell (or other electrochemical device disclosed herein), and the fuel may be reformed or unreformed. Generally, the fuel will be gasified at at least one step of the process. Non-limiting examples of classes of fuels include a carbonaceous material; sulfur; a sulfur-containing organic compound such as thiophene, thiourea and thiophenol; a nitrogen-containing organic compound such as nylon and a protein; ammonia, hydrogen and mixtures thereof. Typically, the fuel selected for the device is application dependent. Examples of a fuel comprising a carbonaceous material include, but are not limited to, conductive carbon, graphite, quasi-graphite, coal, coke, charcoal, fullerene, buckminsterfullerene, carbon black, activated carbon, decolorizing carbon, a hydrocarbon, an oxygen-containing hydrocarbon, carbon monoxide, fats, oils, a wood product, a biomass and combinations thereof. Examples of a hydrocarbon fuel include, but are not limited to, saturated and unsaturated hydrocarbons, aliphatics, alicyclics, aromatics, and mixtures thereof. Other examples of hydrocarbons include gasoline, diesel, kerosene, methane, propane, butane, natural gas, and mixtures thereof. Examples of oxygen-containing hydrocarbon fuels include, but are not limited to, alcohols which further include C₁-C₂₀ alcohols and combinations thereof. Specific examples include methanol, ethanol, propanol, butanol and mixtures thereof. However, almost all oxygen-containing hydrocarbon fuels capable of being oxidized by the anode materials disclosed herein may be used, so long as the fuel is not explosive or does not present any danger at operating temperatures. Gaseous fuels such as hydrogen and SynGas (a mixture of hydrogen and carbon monoxide) may also be used in certain embodiments of the invention.

The anode can be formed from any suitable material. As an example, the anode can be a rechargeable anode, such as is taught in International Patent Application No. PCT/US01/12616, filed Apr. 18, 2001, entitled “An Electrochemical Device and Methods for Energy Conversion,” by T. Tao, et al., published as WO 01/80335 on Oct. 25, 2001, incorporated herein by reference, and can be selected from among metal or metal alloy anodes that are capable of existing in more than two oxidation states or in non-integral oxidation states. Certain metals can be oxidized to one or more oxidation states, any one of these states being of a sufficient electrochemical potential to oxidize the fuel. Conversely, if that metal is oxidized to its highest oxidation state, it may be reduced to more than one lower oxidation state (i.e., at least one having a higher oxidation state than neutral) where the anode is capable of functioning in any of these states. Alternatively, a metal oxide or mixed metal oxide may collectively oxidize fuel where metal ions are reduced by formal non-integer values.

Where a metal anode is used, the anode can be a mixture or an alloy of different metals in some cases (e.g., if the different metals are in the solid state). In such an arrangement, metal atoms in the anode can cycle between two or more oxidation states including metal and various species of metal oxide. The overall reaction described is energetically favorable, thus power can be drawn from an electrical circuit connecting the anode with the cathode.

Examples of anodic material that can be used to form the anode, or compounded with other materials to define an anode, include fluid anodes such as liquid anodes (that is, a material that is a liquid at operating temperatures of the device). In one embodiment, the device is operable, with the anode in a liquid state, at a temperature of less than about 1500° C., less than about 1300° C., less than about 1200° C., less than about 1000° C., or less than about 800° C. By “operable,” it is meant that the device is able to generate electricity, either as an electrochemical device such as a fuel-to-energy conversion device, a fuel cell, or as a rechargeable device such as a battery and/or a chemical or fuel-rechargeable energy conversion unit with the anode in a liquid state, and the anode may not necessarily be a liquid at room temperature. It is understood by those of ordinary skill in the art that anodic temperature can be controlled by selection of anode materials or in the case of a mixture of metals, molten salts, and/or molten oxides, composition and percentages of the respective components, i.e., composition can affect the melting point of the anode. Other non-limiting exemplary operating temperature ranges include a temperature between about 300° C. to about 1500° C., between about 500° C. to about 1300° C., between about 500° C. to about 1200° C., between about 500° C. to about 1000° C., between about 600° C. to about 1000° C., between about 700° C. to about 1000° C., between about 800° C. to about 1000° C., between about 500° C. to about 900° C., between about 500° C. to about 800° C., between about 600° C. to about 800° C., etc.

In some embodiments, the anode can be a pure liquid or can have solid and liquid components, so long as the anode as a whole exhibits liquid- or fluid-like properties. In some cases, the anode can have the consistency of a paste or a highly viscous fluid. Where the anode is a metal, it can consist essentially of a pure metal or can comprise an alloy comprising two or more metals. In one set of embodiments, the anodic material is selected so as to have a standard reduction potential greater than −0.70 V versus the Standard Hydrogen Electrode (determined at room temperature). These values can be obtained from standard reference materials, or measured by using methods known to those of ordinary skill in the art. The anode can comprise any one or more than one of a transition metal, a main group metal, and combinations thereof. Metals such as copper, molybdenum, mercury, iridium, palladium, antimony, rhenium, bismuth, platinum, silver, arsenic, rhodium, tellurium, selenium, osmium, gold, lead, germanium, tin, indium, thallium, cadmium, gadolinium, chromium nickel, iron, tungsten, cobalt, zinc, vanadium, or combinations thereof, can also be useful. Examples of alloys include, but are not limited to, 5% lead with reminder antimony, 5% platinum with reminder antimony, 5% copper with reminder indium, 20% lead, 10% silver, 40% indium, 5% copper. In another set of embodiments, the liquid anode of the electrochemical device may include a molten salt, such as carbonates, sulfates, chlorides, fluorides, phosphates and nitrates, and/or a molten oxide, such as antimony oxide, and/or combinations thereof.

Although liquid anodes are more commonly used in the invention (e.g., liquid metal, molten salt, molten oxides, etc.), solid anodes can be used as well, including metals such as main group metals, transition metals such as nickel, lanthanides, actinides, ceramics (optionally doped with any metal listed herein). Indeed, any suitable anode may be used with the present invention. Other suitable solid anodes are disclosed in references incorporated herein.

The following documents are each incorporated herein by reference: International Patent Application No. PCT/US99/04741, filed Mar. 3, 1999, entitled “A Carbon-Oxygen Electricity Generating Unit,” by T. Tao, et al., published as WO 99/45607 on Sep. 10, 1999; International Patent Application No. PCT/US01/12616, filed Apr. 18, 2001, entitled “An Electrochemical Device and Methods for Energy Conversion,” by T. Tao, et al., published as WO 01/80335 on Oct. 25, 2001; U.S. patent application Ser. No. 09/819,886, filed Mar. 28, 2001, entitled “A Carbon-Oxygen Fuel Cell,” by T. Tao, published as U.S. Patent Application Publication No. 2002/0015877 on Feb. 7, 2002, now U.S. Pat. No. 6,692,861, issued Feb. 17, 2004; International Patent Application No. PCT/US02/37290, filed Nov. 20, 2002, entitled “An Electrochemical System and Methods for Control Thereof,” by T. Tao, et al., published as WO 03/044887 on May 30, 2003; International Patent Application No. PCT/US03/03642, filed Feb. 6, 2003, entitled “Current Collectors,” by T. Tao, et al., published as WO 03/067683 on Aug. 14, 2003; U.S. Provisional Patent Application Ser. No. 60/492,924, filed Aug. 6, 2003, entitled “Electroplating Systems and Methods,” by T. Tao, et al.; U.S. patent application Ser. No. 11/294,676, filed Dec. 5, 2005, entitled “Oxidation Facilitator,” by A. Blake, et al.; U.S. patent application Ser. No. 11/167,079, filed Jun. 24, 2005, entitled “Components for Electrochemical Devices Including Multi-Unit Device Arrangements,” by A. Blake, et al., published as U.S. Patent Application Publication No. 2006/0040167 on Feb. 23, 2006; and International Patent Application No. PCT/US02/20099, filed Jun. 25, 2002, entitled “Electrode Layer Arrangements in an Electrochemical Device,” by T. Tao, et al., published as WO 03/001617 on Jan. 3, 2003.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
providing a template for a ceramic porous structure;
at least partially infusing the template with a liquid comprising a ceramic precursor; and
heating the ceramic precursor to a temperature that allows the precursor to form a ceramic having interconnected channels and an average pore size, as determined by mercury porosimetry, of less than about 300 micrometers.

2. The method of claim 1, comprising forming a ceramic green body, and thereafter, heating the ceramic green body to form the ceramic.

3. The method of claim 2, comprising heating the ceramic precursor or the ceramic green body to a temperature that causes the template to at least partially decompose.

4. The method of claim 1, wherein the average pore size is determined using mercury porosimetry.

5. The method of claim 1, wherein the liquid is a slurry.

6. The method of claim 1, wherein the template is a foam.

7. The method of claim 6, wherein the foam has a porosity of at least about 300 pores per inch.

8. The method of claim 1, wherein the template comprises a polymer.

9. The method of claim 1, wherein the template comprises a polyurethane.

10. The method of claim 1, wherein the template is compressible.

11. The method of claim 1, wherein the act of infusing the template with a liquid comprises subjecting the template to a pressure that facilitates movement of the liquid into the foam.

12. The method of claim 11, wherein the pressure is applied mechanically.

13. The method of claim 1, wherein the temperature is at least about 300° C.

14. The method of claim 13, wherein the temperature is at least about 900° C.

15. The method of claim 1, comprising gasifying the template.

16. The method of claim 1, wherein the ceramic precursor comprises Al₂O₃.

17. The method of claim 1, wherein the ceramic precursor comprises ZrO₂.

18. A method, comprising:
providing a template for a ceramic porous structure;
at least partially infusing the template with a liquid comprising a ceramic precursor;
causing the ceramic precursor to form a ceramic; and
removing substantially all of the template from the ceramic.

19 The method of claim 18, wherein the liquid is a slurry.

20. The method of claim 18, wherein the template is a foam.

21. The method of claim 20, wherein the foam has a porosity of at least about 300 pores per inch.

22. The method of claim 18, wherein the act of infusing the template with a liquid comprises subjecting the template to a pressure that facilitates movement of the liquid into the template.

23. The method of claim 18, wherein the temperature is at least about 300° C.

24. The method of claim 23, wherein the temperature is at least about 900° C.

25. The method of claim 18, comprising gasifying the template.

26. The method of claim 18, comprising causing the template to at least partially decompose.

27. The method of claim 18, wherein the ceramic precursor comprises Al₂O₃.

28. The method of claim 18, wherein the ceramic precursor comprises ZrO₂.

29-44. (canceled)

45. A method, comprising:
providing an electrochemical device comprising an electrode, a substantial portion of which is liquid at an operating temperature of the device, and a porous article adjacent at least a portion of the electrode for supporting the electrode in a liquid state, wherein the porous article is substantially permeable to a gas; and
operating the device with substantial containment, by the porous article, of the electrode when the electrode is liquid while allowing passage, through the porous article, of the gas which participates in a reaction involving the device.

46. The method of claim 45, wherein the gas is air.

47. The method of claim 45, wherein the porous article is essentially impermeable to the electrode in a liquid state.
